(19) United States
(12) Patent Application Publication
(10) Pub. No.: US 2025/0218108 A1
(43) Pub. Date: Jul. 3, 2025

(54) VEHICLE SURROUNDING ENVIRONMENT DISPLAY DEVICE AND METHOD FOR CONTROLLING VEHICLE SURROUNDING ENVIRONMENT DISPLAY DEVICE

(71) Applicants: TOYOTA JIDOSHA KABUSHIKI KAISHA, Toyota-shi (JP); DENSO CORPORATION, Kariya-shi (JP)

(72) Inventors: Yuki YAMAMOTO, Toyota-shi (JP); Hideaki FURUSE, Kariya-shi (JP); Naoyuki OKADA, Kariya-shi (JP)

(73) Assignees: TOYOTA JIDOSHA KABUSHIKI KAISHA, Toyota-shi (JP); DENSO CORPORATION, Kariya-shi (JP)

(21) Appl. No.: 18/949,945

(22) Filed: Nov. 15, 2024

(30) Foreign Application Priority Data
Dec. 28, 2023 (JP) 2023-223228

(51) Int. Cl. G06T 15/20; B60R 1/27; G06V 20/56

(52) U.S. Cl. CPC G06T 15/20; B60R 1/27; G06V 20/56; B60R 2300/607; G06T 2200/24

(57) ABSTRACT

A vehicle surrounding environment display device configured to generate a virtual space corresponding to a surrounding environment of a host vehicle on the basis of detection information from an external sensor of the host vehicle and display an image inside the virtual space viewed from a virtual viewpoint operated by a user of the host vehicle on a display, wherein a three-dimensional host vehicle icon corresponding to the host vehicle is disposed in the virtual space, and when the virtual viewpoint is located in an icon transformation region set above the rear or front of the host vehicle icon, the host vehicle icon is displayed in a stretching display that is stretched in length of the host vehicle icon compared to when the virtual viewpoint is not located in the icon transformation region.

### CROSS REFERENCE TO RELATED APPLICATIONS

This application is based upon and claims the benefit of priority from Japanese Patent Application No. 2023-223228, filed on Dec. 28, 2023, the entire contents of which are incorporated herein by reference.

### TECHNICAL FIELD

The present invention relates to a vehicle surrounding environment display device and a control method for the vehicle surrounding environment display device.

### BACKGROUND

Conventionally, as a technical document related to a vehicle surrounding environment display device, Japanese Patent Application Laid-Open No. 2020-088697 is known. This publication discloses a surrounding monitoring device that generates a virtual space including a vehicle icon and projects the surrounding environment of the vehicle as a three-dimensional image within the virtual space. In this device, the user can freely view the environment around the vehicle by operating a virtual viewpoint within the virtual space.

### SUMMARY

By the way, when displaying the virtual space viewed from the virtual viewpoint on a display for the user to recognize, as in the conventional device described above, it becomes difficult to grasp the positional relationship between the host vehicle and surrounding objects compared to the actual environment. Therefore, there is a need for a technology that corrects the user's recognition to suppress the sense of discomfort in recognizing the surrounding environment of the host vehicle.

According to one aspect of the present disclosure, there is provided a vehicle surrounding environment display device configured to generate a virtual space corresponding to a surrounding environment of a host vehicle on the basis of detection information from an external sensor of the host vehicle and display an image inside the virtual space viewed from a virtual viewpoint operated by a user of the host vehicle on a display, wherein a three-dimensional host vehicle icon corresponding to the host vehicle is disposed in the virtual space, and when the virtual viewpoint is located in an icon transformation region set above the rear or front of the host vehicle icon, the host vehicle icon is displayed in a stretching display that is stretched in length of the host vehicle icon compared to when the virtual viewpoint is not located in the icon transformation region.

In the vehicle surrounding environment display device according to one aspect of the present disclosure, when the virtual viewpoint is not located in the icon transformation region, the farther the virtual viewpoint is from the icon transformation region, the closer the total length of the host vehicle icon is to a preset initial length, and the closer the virtual viewpoint is to the icon transformation region, the more the total length of the host vehicle icon is stretched.

According to another aspect of the present disclosure, there is provided a method for controlling a vehicle surrounding environment display device configured to generate a virtual space corresponding to a surrounding environment of a host vehicle on the basis of detection information from an external sensor of the host vehicle and display an image inside the virtual space viewed from a virtual viewpoint operated by a user of the host vehicle on a display, wherein a three-dimensional host vehicle icon corresponding to the host vehicle is disposed in the virtual space, and when the virtual viewpoint is located in an icon transformation region set above the rear or front of the host vehicle icon, the host vehicle icon is displayed in a stretching display that is stretched in length of the host vehicle icon compared to when the virtual viewpoint is not located in the icon transformation region.

According to each aspect of the present disclosure, it is possible to suppress the user's sense of discomfort in recognizing the surrounding environment of the host vehicle using the virtual space.

### BRIEF DESCRIPTION OF THE DRAWINGS

FIG. 1 is a block diagram showing a vehicle surrounding environment display device according to an embodiment.

FIG. 2 is a diagram for explaining the host vehicle icon and the virtual viewpoint.

FIG. 3 is a diagram for explaining the drawing status of objects in the virtual space.

FIG. 4A is a diagram for explaining an example of the transformation status of the host vehicle icon when the virtual viewpoint is located on the side of the host vehicle icon outside the icon transformation region.

FIG. 4B is a diagram for explaining an example of the transformation status of the host vehicle icon when the virtual viewpoint starts rotating to the right and approaches the icon transformation region behind the host vehicle icon.

FIG. 4C is a diagram for explaining an example of the transformation status of the host vehicle icon when the virtual viewpoint rotates further to the right.

FIG. 4D is a diagram for explaining an example of the transformation status of the host vehicle icon when the virtual viewpoint rotates to the right side of the host vehicle icon.

FIG. 5A is a diagram showing an example of area division according to the position of objects in a plan view.

FIG. 5B is a diagram showing an example of area division according to the height of objects in a side view.

FIG. 6 is a diagram for explaining changes in the drawing status in the virtual space due to differences in the height of objects on the side of the host vehicle.

FIG. 7 is a flowchart showing an example of a method for controlling the vehicle surrounding environment display device according to the present embodiment.

### DETAILED DESCRIPTION

Hereinafter, an embodiment of the present disclosure will be described with reference to the drawings.

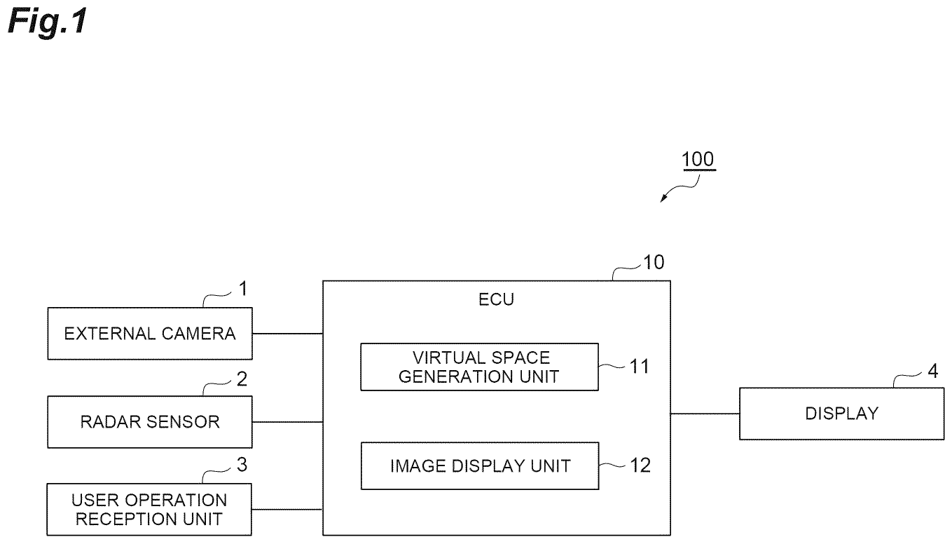

FIG. 1 is a block diagram showing a vehicle surrounding environment display device 100 according to an embodiment. The vehicle surrounding environment display device 100 shown in FIG. 1 is mounted on a vehicle such as a passenger car or a truck. Hereinafter, the vehicle on which the vehicle surrounding environment display device 100 is mounted is referred to as the host vehicle. The vehicle surrounding environment display device 100 is a device for supporting the user's recognition of the surrounding environment of the vehicle. The vehicle surrounding environment display device 100 generates a virtual space reflecting the surrounding environment of the host vehicle and displays an image inside the virtual space viewed from a virtual viewpoint operated by the user on a display. The vehicle surrounding environment display device 100 displays the surrounding environment of the host vehicle on the display as a so-called 3D view.

The user may be the driver of the host vehicle, an occupant of the host vehicle, or the owner of the host vehicle. The user may be an operator who performs remote support for the host vehicle using a remote support system. In the remote support system, the operator can make decisions on the driving of the host vehicle (such as proceeding, turning right or left, stopping, etc.) or perform driving operations of the host vehicle through remote support equipment provided outside the vehicle and capable of communicating with the host vehicle. The host vehicle is not limited to a vehicle that can be remotely supported by the remote support system. The host vehicle may be a vehicle with an autonomous driving function or a vehicle without an autonomous driving function.

### [Configuration of Vehicle Surrounding Environment Display Device]

As shown in FIG. 1, the vehicle surrounding environment display device 100 includes an Electronic Control Unit (ECU) 10 that comprehensively manages the device. The ECU 10 is an electronic control unit having a Central Processing Unit (CPU) and a storage unit. The storage unit is composed of, for example, a Read Only Memory (ROM), a Random Access Memory (RAM), and an Electrically Erasable Programmable Read-Only Memory (EEPROM). In the ECU 10, for example, various functions are realized by executing a program stored in the storage unit on the CPU. The ECU 10 may be composed of a plurality of electronic units. The ECU 10 is connected to an external camera 1 (external sensor), a radar sensor 2 (external sensor), a user operation reception unit 3, and a display 4.

The external camera 1 is an imaging device that captures the external situation of the host vehicle. The external camera 1 includes, for example, a front camera that captures the front of the host vehicle, a rear camera that captures the rear of the host vehicle, and a plurality of side cameras that capture the left and right sides of the host vehicle, respectively. The number of cameras of the external camera 1 is not particularly limited and may be one. The external camera 1 transmits captured image information to the ECU 10.

The radar sensor 2 is a detection device that detects objects around the host vehicle using radio waves (for example, millimeter waves) or light. The radar sensor 2 can include a millimeter wave radar or a LiDAR (Light Detection and Ranging). The radar sensor 2 transmits object detection information about the detected objects to the ECU 10. The radar sensor 2 and the external camera 1 constitute external sensors for detecting the surrounding environment of the host vehicle. The object detection information of the radar sensor 2 or the captured image information of the external camera 1 corresponds to the detection information of the external sensor.

The user operation reception unit 3 is a device that receives operations for the virtual viewpoint by the user. The user operation reception unit 3 can be, for example, an input unit of a Human Machine Interface (HMI) provided in the host vehicle. The input unit may include, for example, a touch panel display, buttons, levers, switches, etc. The user operation reception unit 3 may also be capable of receiving operations by voice recognition or gestures.

The user operation reception unit 3 may be an input device of a mobile terminal or computer connected to the host vehicle. The user operation reception unit 3 may also be used as an operator terminal of the remote support system.

The display 4 is, for example, a center display mounted on the dashboard of the host vehicle. The display 4 may be a display of a tablet-type computer that can be installed in the host vehicle, or a Head Up Display (HUD). The display 4 does not need to be installed in the host vehicle. The display 4 may be an operator display of a remote support system provided in a facility away from the host vehicle. The display 4 may be a display of a mobile terminal carried by the user, or a display of the user's tablet-type computer or desktop-type computer.

Next, the functional configuration of the ECU 10 will be described. As shown in FIG. 1, the ECU 10 includes a virtual space generation unit 11 and an image display unit 12. Some of the functions of the ECU 10 described below may be executed by a server, mobile terminal, or computer that can communicate with the host vehicle. The server that can communicate with the host vehicle can be, for example, a server of the remote support system. The computer can be, for example, a tablet-type computer or a desktop-type computer.

The virtual space generation unit 11 generates a virtual space corresponding to the surrounding environment of the host vehicle based on the captured image information of the external camera 1. The surrounding environment of the host vehicle includes, for example, the position of lane lines of the lane in which the host vehicle is traveling. The surrounding environment of the host vehicle may include the situation (position, travel direction, etc.) of other vehicles such as preceding vehicles and adjacent vehicles traveling in parallel.

The virtual space is generated, for example, as a 3D image synthesized from multiple images. The method of synthesizing images is not particularly limited. The virtual space generation unit 11 generates the virtual space as a 3D image by projecting each image onto a global coordinate system that serves as a reference for the virtual space and corresponding overlapping pixels.

The virtual space generation unit 11 arranges a host vehicle icon corresponding to the host vehicle in the virtual space. The host vehicle icon is arranged as a three-dimensional icon in the shape of a car. The host vehicle icon can be formed by polygon, voxel, or other CG processing. The virtual space generation unit 11 may generate a host vehicle icon reflecting the actual state of the host vehicle. The virtual space generation unit 11 may reflect the lighting state of the actual host vehicle's lamps in the lighting state of the lamps in the host vehicle icon. The lighting state of the host vehicle's lamps includes, for example, the lighting state of the host vehicle's headlights, direction indicator lights, and brake lights. The virtual space generation unit 11 may reflect the lighting state of the actual host vehicle's lamps in the lighting state of the lamps in the host vehicle icon. The shape and size of the host vehicle icon are preset according to the vehicle type.

When the virtual space generation unit 11 recognizes an object based on the captured image information of the external camera 1, it arranges an icon corresponding to the object in the virtual space. The object may be a tire stopper provided in a parking lot or the like, a curb provided in a parking lot or the like, another vehicle, or a pedestrian. The virtual space generation unit 11 may recognize other vehicles based on the object detection information of the radar sensor 2 instead of the captured image information of the external camera 1, or may recognize other vehicles using both the external camera 1 and the radar sensor 2.

The virtual space generation unit 11 may recognize other vehicles and the like around the host vehicle using information about the surrounding environment recognized by other vehicles through inter-vehicle communication. The virtual space generation unit 11 may obtain image information from cameras installed on the road and various traffic information by communicating with a traffic information management server managed by the government. The virtual space generation unit 11 may recognize other vehicles and the like using image information from cameras installed on the road and various traffic information.

The virtual space generation unit 11 may also predict the behavior of other vehicles based on the captured image information of the external camera 1 or the object detection information of the radar sensor 2. In this case, the virtual space generation unit 11 displays the prediction result of the behavior of other vehicles in association with the other vehicle icons. The virtual space generation unit 11 may display the predicted route of other vehicles using arrow icons or the like. The virtual space generation unit 11 may display the predicted stop position of decelerating other vehicles using block-type icons extending in the lane width direction. Similarly, the virtual space generation unit 11 may display the prediction result of the behavior of pedestrians in association with pedestrian icons.

The method of generating the virtual space is not limited to the method of synthesizing multiple images of the external camera 1, and other methods are also possible. The virtual space generation unit 11 does not need to generate the virtual space as a 3D image as long as the surrounding environment of the host vehicle can be recognized by the user. The virtual space generation unit 11 may generate a digital virtual space not as an image, but by arranging the host vehicle icon, lane lines, and other vehicle icons so that the positional relationship between the host vehicle and other vehicles can be understood.

The image display unit 12 displays an image inside the virtual space generated by the virtual space generation unit 11 viewed from the virtual viewpoint operated by the user on the display 4. The image display unit 12 moves the virtual viewpoint 50 according to the user's operation input to the user operation reception unit 3.

The image display unit 12 changes the shape of the host vehicle icon M according to the position of the virtual viewpoint 50. This corrects the user's recognition of the position of the host vehicle icon M and other vehicle icons. Specifically, the image display unit 12 changes the total length of the host vehicle icon M as an example, according to the position of the virtual viewpoint 50.

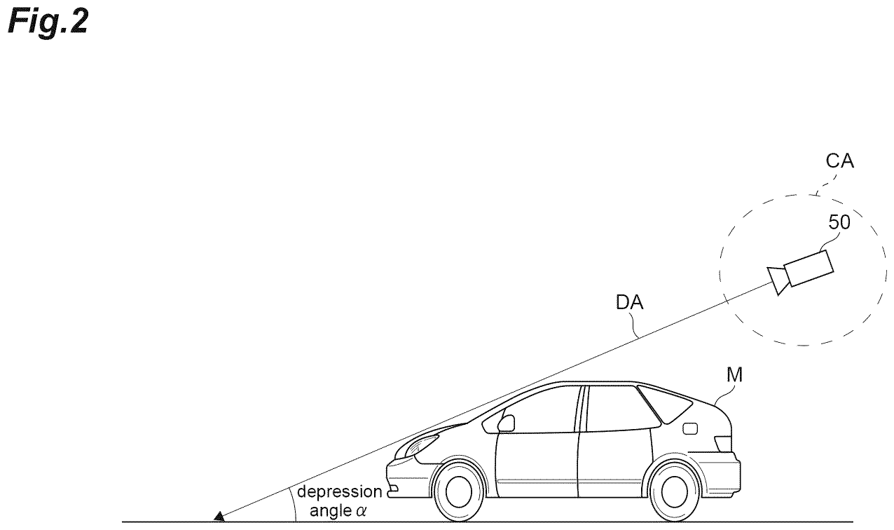

FIG. 2 is a diagram for explaining the host vehicle icon and the virtual viewpoint. FIG. 2 shows the host vehicle icon M, the virtual viewpoint 50, and the icon transformation region CA. The plane on which the host vehicle icon M is arranged corresponds to the horizontal plane of the global coordinate system. FIG. 2 shows the line of sight DA of the virtual viewpoint 50 and the depression angle a of the virtual viewpoint 50. In FIG. 2, the virtual viewpoint 50 is illustrated as a camera icon for ease of understanding. The depression angle a is the angle formed between the plane on which the host vehicle icon M is arranged or the horizontal plane of the global coordinate system and the line of sight DA within the vertical plane. Note that it is not essential to display the virtual viewpoint 50 as an icon in the virtual space.

The icon transformation region CA is a region preset for transforming the host vehicle icon M. As shown in FIG. 2, the icon transformation region CA is a spherical region set above the rear of the host vehicle icon M as an example. The icon transformation region CA may be a rectangular region, a cylindrical region, a triangular pyramid region, or a polygonal region. The icon transformation region CA may be a region that expands in a fan shape from the rear of the host vehicle icon M diagonally upward. The icon transformation region CA may be a region that expands in a fan shape in cross-section from the host vehicle icon M diagonally upward toward the rear of the host vehicle icon M. The shape of the icon transformation region CA is not particularly limited.

The icon transformation region CA may be set to include the initial position of the virtual viewpoint 50. The initial position of the virtual viewpoint is the position in the virtual space where the virtual viewpoint 50 is preset when the image display function of the vehicle surrounding environment display device 100 is activated. The icon transformation region CA may be a region consisting of a single coordinate point in the global coordinate system. The coordinate point may be the initial position of the virtual viewpoint 50.

The width of the icon transformation region CA may be set not to exceed the width of the host vehicle icon M. If the overall width of the host vehicle icon M changes due to the transformation, the width of the icon transformation region CA can be set not to exceed the width of the host vehicle icon M when the width is shortest.

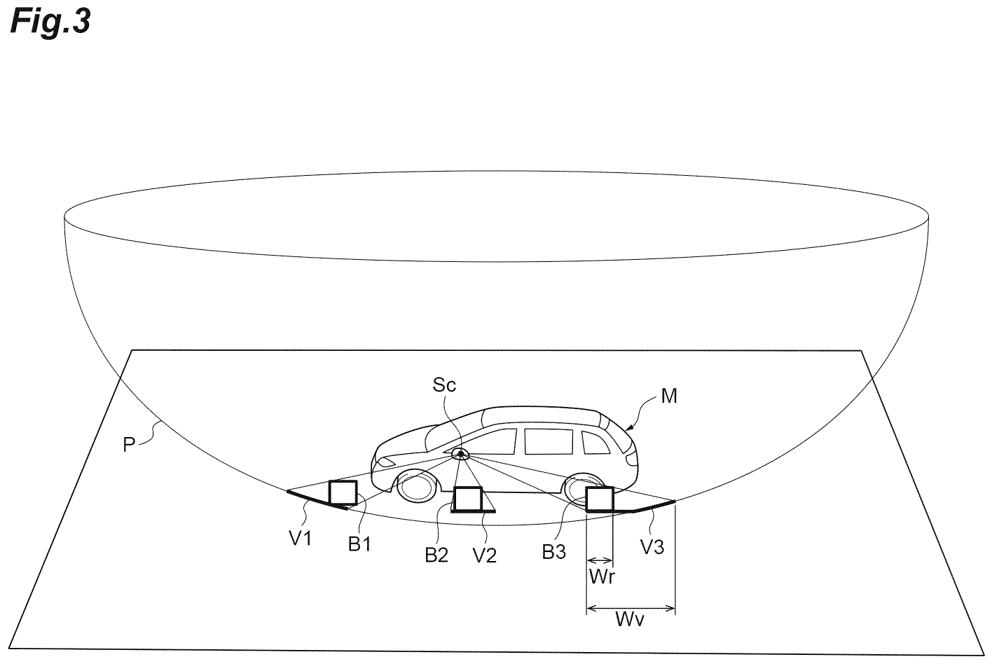

Here, the drawing status of objects in the virtual space will be explained with reference to FIG. 3. FIG. 3 is a diagram for explaining the drawing status of objects in the virtual space. FIG. 3 shows the side camera Sc of the host vehicle, the object B1 located on the front side of the host vehicle, the object B2 located on the side of the host vehicle, the object B3 located on the rear side of the host vehicle, and the projection plane P corresponding to the display in the virtual space. Objects B1 to B3 are blocks of the same size and shape. Here, for ease of understanding, only the side end portions of the blocks are shown as square icons. The projection plane P is a bowl-shaped plane used to explain the size of objects B1 to B3 drawn in the virtual space. The projection plane P is formed based on the side camera Sc. Note that the position of the side camera Sc is not limited to the side-view mirror of the host vehicle and can be any position.

In the situation shown in FIG. 3, the size (width of the top surface) of the object B1 in the virtual space generated from the captured image of the object B1 viewed from the side camera Sc is indicated by the symbol V1. The size (width of the top surface) of the object B2 in the virtual space generated from the captured image of the object B2 viewed from the side camera Sc is indicated by the symbol V2. Similarly, the size (width of the top surface) of the object B3 in the virtual space generated from the captured image of the object B3 viewed from the side camera Sc is indicated by the symbol V3. The size in the virtual space can be considered to correspond to the size projected onto the projection plane P or the floor of the virtual space (corresponding to the road surface on which the host vehicle icon M is placed).

In this case, as shown in FIG. 3, due to the positional relationship between the side camera Sc and the objects B1 to B3, there is a difference between the actual size of the objects B1 to B3 and their size in the virtual space. For the object B3, the size Wv in the virtual space becomes nearly three times larger than the actual size Wr. Therefore, when the user tries to recognize the positional relationship between the host vehicle and the object B3 using the virtual space, there is a possibility of recognition misalignment.

Therefore, the image display unit 12 performs a stretching display to stretch the total length (length in the front-rear direction) of the host vehicle icon M when the virtual viewpoint 50 is located in the icon transformation region CA compared to when the virtual viewpoint 50 is not located in the icon transformation region CA. By performing the stretching display control of the host vehicle icon M, the image display unit 12 suppresses the user's sense of discomfort in recognizing the surrounding environment of the host vehicle when using the virtual space. Note that the image display unit 12 is aware of the positional information of the virtual viewpoint 50 in the virtual space.

The host vehicle icon M has a preset total length (initial setting length) as an initial setting. In the stretching display, the total length of the host vehicle icon M is stretched to be longer than the initial setting length.

The image display unit 12 may perform the stretching display by uniformly stretching the entire host vehicle icon M. The image display unit 12 may perform the stretching display by stretching the rear overhang portion behind the rear axle of the host vehicle icon M. The image display unit 12 may perform the stretching display control of the entire host vehicle icon M or the rear overhang portion of the host vehicle icon M so that the center position does not change with the center of the host vehicle icon M as a reference. The image display unit 12 may perform the stretching display of the entire host vehicle icon M or the rear overhang portion of the host vehicle icon M so that the position of the rear axle does not change with respect to the rear axle.

Note that the image display unit 12 may stretch the front overhang portion in front of the front axle of the host vehicle icon M when the virtual viewpoint 50 is located in the icon transformation region CA set above and in front of the host vehicle icon M. In this case, the image display unit 12 may perform the stretching display control based on the center of the host vehicle icon M or based on the front axle of the host vehicle icon M.

The image display unit 12 may transform the host vehicle icon M according to the positional relationship between the virtual viewpoint 50 and the icon transformation region CA even when the virtual viewpoint 50 is not located in the icon transformation region CA. That is, the image display unit 12 may smoothly transform the host vehicle icon M as an animation according to the user's operation of the virtual viewpoint 50.

Specifically, the image display unit 12 may transform the host vehicle icon M so that the total length of the host vehicle icon M approaches the initial setting length as the distance between the virtual viewpoint 50 and the icon transformation region CA increases when the virtual viewpoint 50 is located outside the icon transformation region CA. In this case, the distance between the virtual viewpoint 50 and the icon transformation region CA may be grasped as a straight-line distance within the global coordinate system. The distance between the virtual viewpoint 50 and the icon transformation region CA may be counted as the distance along the rotation trajectory in the case of rotational movement. When there are multiple icon transformation regions CA, the distance to the nearest icon transformation region CA from the virtual viewpoint 50 is used.

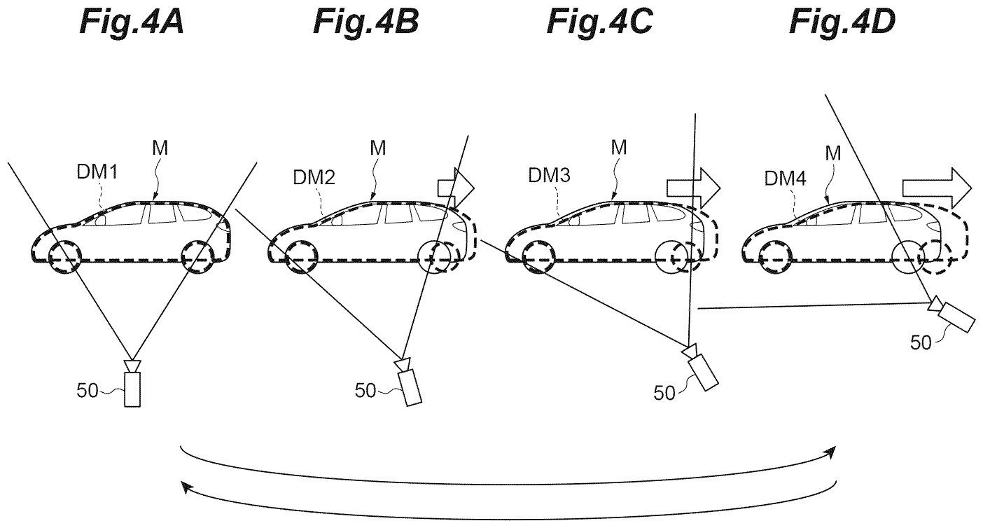

The change in the host vehicle icon M when the virtual viewpoint 50 is not located in the icon transformation region CA will be explained with reference to FIG. 4A to FIG. 4D. FIG. 4A is a diagram for explaining an example of the transformation status of the host vehicle icon M when the virtual viewpoint 50 is located on the side of the host vehicle icon M outside the icon transformation region. FIG. 4B is a diagram for explaining an example of the transformation status of the host vehicle icon M when the virtual viewpoint 50 starts rotating to the right and approaches the icon transformation region behind the host vehicle icon M. FIG. 4C is a diagram for explaining an example of the transformation status of the host vehicle icon M when the virtual viewpoint 50 rotates further to the right. FIG. 4D is a diagram for explaining an example of the transformation status of the host vehicle icon M when the virtual viewpoint 50 rotates to the right side of the host vehicle icon M.

In FIGS. 4A to 4D, the transformation status of the host vehicle icon M viewed from the side is shown as dashed lines DM1 to DM4. In FIGS. 4A to 4D, the host vehicle icon M is stretched backward based on the front axle of the host vehicle icon M.

As shown in FIGS. 4A to 4D, the image display unit 12 stretches the total length of the host vehicle icon M as the virtual viewpoint 50 rotates to the right and approaches the icon transformation region CA. When the virtual viewpoint 50 rotates to the left and moves away from the icon transformation region CA according to the user's operation, the image display unit 12 transforms the host vehicle icon M so that the total length returns to the initial setting length. That is, the image display unit 12 shrinks the total length of the host vehicle icon M to approach the initial setting length as the virtual viewpoint 50 moves away from the icon transformation region CA.

In this way, the image display unit 12 smoothly transforms the host vehicle icon M according to the positional relationship between the virtual viewpoint 50 and the icon transformation region CA. This allows the image display unit 12 to suppress the user's sense of discomfort in the transformation of the host vehicle icon M.

Next, the method of transforming the host vehicle icon M according to the position of objects will be explained. The image display unit 12 may change the transformation rate of the total length of the host vehicle icon M according to the position of objects around the host vehicle.

As shown in FIG. 3, the sizes V1 to V3 of the objects of the same size B1 to B3 change in the virtual space according to their positions relative to the host vehicle icon M. The distance from the side camera Sc becomes longer in the order of object B2, object B1, and object B3. The sizes V1 to V3 in the virtual space increase in the order of object B2, object B1, and object B3. Therefore, the image display unit 12 may change the transformation mode of the host vehicle icon M according to the position of objects around the host vehicle icon M.

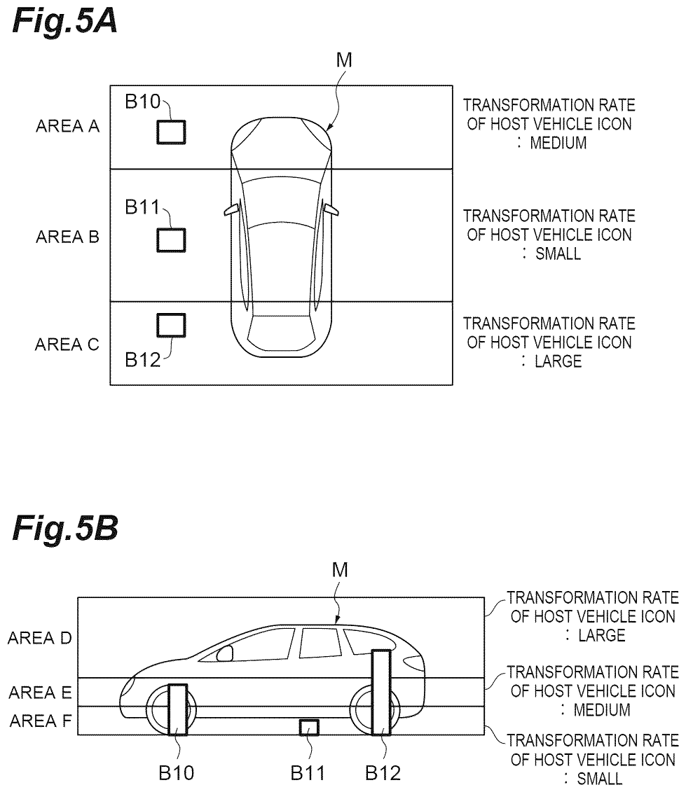

Here, FIG. 5A is a diagram showing an example of area division according to the position of objects in a plan view. In FIG. 5A, the surroundings of the host vehicle icon M are divided into three areas in the front-rear direction of the host vehicle icon M. FIG. 5A shows the area A in front of the host vehicle, the area B in the center of the host vehicle, and the area C behind the host vehicle. The areas A to C are set as rectangular areas with a certain width in the lateral direction for example centered on the host vehicle icon M. Objects B10 to B12 are objects located in areas A to C, respectively.

As shown in FIG. 5A, the image display unit 12 may change the host vehicle icon transformation rate according to the area in which the object is located. The host vehicle icon transformation rate corresponds to the degree to which the total length of the host vehicle icon M is stretched. Specifically, the image display unit 12 sets the host vehicle icon transformation rate to medium when only the object B10 in area A is present. The image display unit 12 sets the host vehicle icon transformation rate to be small when only the object B11 in area B is present. The image display unit 12 sets the host vehicle icon transformation rate to high when only the object B12 in area C is present. As an example, the transformation rate can be set to a value near 100% for large, a value around 50% for medium, and a value less than 20% for small.

In this way, the image display unit 12 changes the total length of the host vehicle icon M according to the position of objects around the host vehicle. This allows the image display unit 12 to correct the total length of the host vehicle icon M so that the user can easily recognize the positional relationship between the objects and the host vehicle icon M.

The area division is not limited to the division method shown in FIG. 5A, and other methods are also possible. The areas may be divided according to the distance from the left and right side cameras Sc of the host vehicle. The areas may be divided into four or more, rather than three.

The image display unit 12 may not change the total length of the host vehicle icon M when no object is detected within a preset object proximity determination area. The detection of objects is performed based on the captured image of the external camera 1 or the detection result of the radar sensor 2. The object proximity determination area is an area in the actual space set to include the host vehicle. The object proximity determination area is set to determine whether to change the total length of the host vehicle icon M.

The image display unit 12 may for example set the actual space areas corresponding to areas A and C in the virtual space of FIG. 5A as the object proximity determination areas. In this case, when no object is present in areas A and C and only the object B11 in area B is present, the image display unit 12 does not need to change the total length of the host vehicle icon M from the initial setting length. The image display unit 12 does not change the total length of the host vehicle icon M from the initial setting length even if the virtual viewpoint 50 is located in the icon transformation region CA. On the other hand, when the object B10 in area A or the object B12 in area C is present, the image display unit 12 changes the total length of the host vehicle icon M according to the position of the virtual viewpoint 50.

The object proximity determination area is not limited to the actual space areas corresponding to areas A and C. The object proximity determination area may be an actual space area corresponding to either area A or area C, or an actual space area corresponding to all areas A to C. The object proximity determination area may be an area within a certain distance from the host vehicle. The object proximity determination area may be an area within a certain distance from the host vehicle in the lateral direction excluding the front and rear areas of the host vehicle.

Next, the method of transforming the host vehicle icon M according to the height of objects will be explained. The image display unit 12 may change the total length of the host vehicle icon M according to the height of objects around the host vehicle.

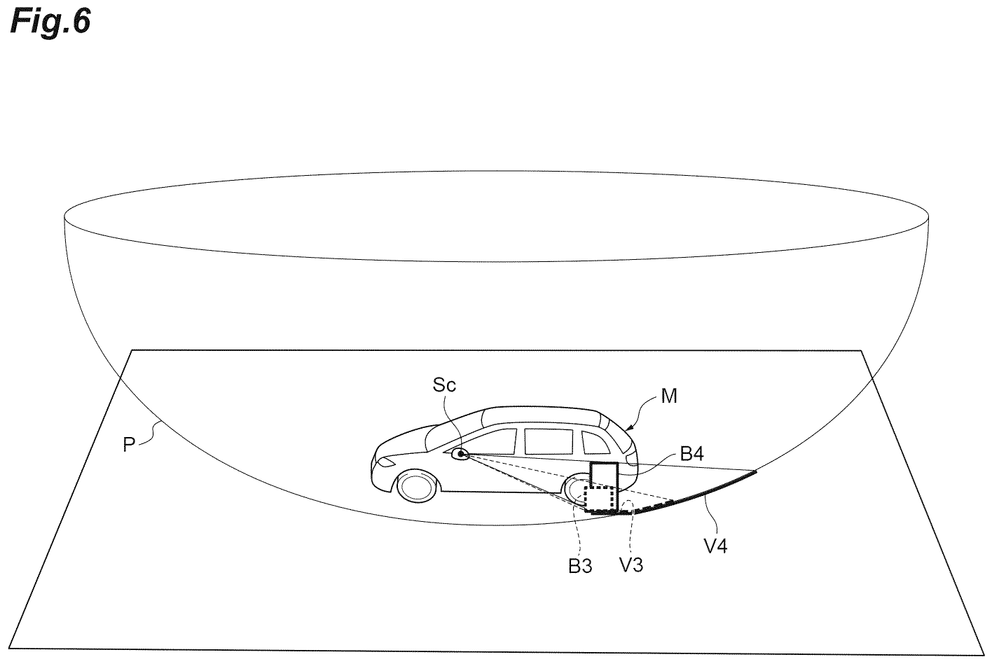

The image display unit 12 may transform the host vehicle icon M according to the height of objects around the host vehicle. FIG. 6 is a diagram for explaining changes in the drawing status in the virtual space due to differences in the height of objects on the side of the host vehicle. FIG. 6 shows the object B4, which is taller than the object B3. The object B4 is a block of the same shape as the object B3 except for the height and is located in the same position as the object B3. In this case, as shown in FIG. 6, the size V4 (top surface in the virtual space) of the object B4 in the virtual space becomes larger than the size V3 of the shorter object B3 in the virtual space.

Here, FIG. 5B is a diagram showing an example of area division according to the height of objects in a side view. In FIG. 5B, the areas D to F divided in the vertical direction of the host vehicle icon M are shown. Specifically, the area D above the host vehicle, the area E in the middle of the host vehicle, and the area F below the host vehicle are shown. In FIG. 5B, objects B10 to B12 are objects of different heights. The heights of the top surfaces of objects B10 to B12 correspond to areas D to F, respectively.

As shown in FIG. 5B, the image display unit 12 may change the host vehicle icon transformation rate according to the height of objects. Specifically, the image display unit 12 sets the host vehicle icon transformation rate to medium when only the object B10 corresponding to the height of area E is present. The image display unit 12 sets the host vehicle icon transformation rate to a small value when only the object B11 corresponding to the height of area F is present. The image display unit 12 sets the host vehicle icon transformation rate to be large when only the object B12 corresponding to the height of area D is present.

In this way, the image display unit 12 changes the total length of the host vehicle icon M according to the height of objects around the host vehicle. This allows the image display unit 12 to correct the total length of the host vehicle icon M so that the user can easily recognize the positional relationship between the object and the host vehicle icon M.

The vertical area division is not limited to the division method shown in FIG. 5A, and other methods are also possible. The areas may be divided into not limited to four or more instead of three. The image display unit 12 may change the total length of the host vehicle icon M considering both the position and height of objects. The image display unit 12 may not change the total length of the host vehicle icon M when the object is present only in area B in the plan view and the height of the object is included in area F in the side view.

### [Program]

A program causes the ECU 10 to function as the virtual space generation unit 11 and the image display unit 12 described above. The program is provided by a non-temporary recording medium such as a ROM or a semiconductor memory. In addition, the program may be provided via communication such as a network.

### [Method for Controlling Vehicle Surrounding Environment Display Device]

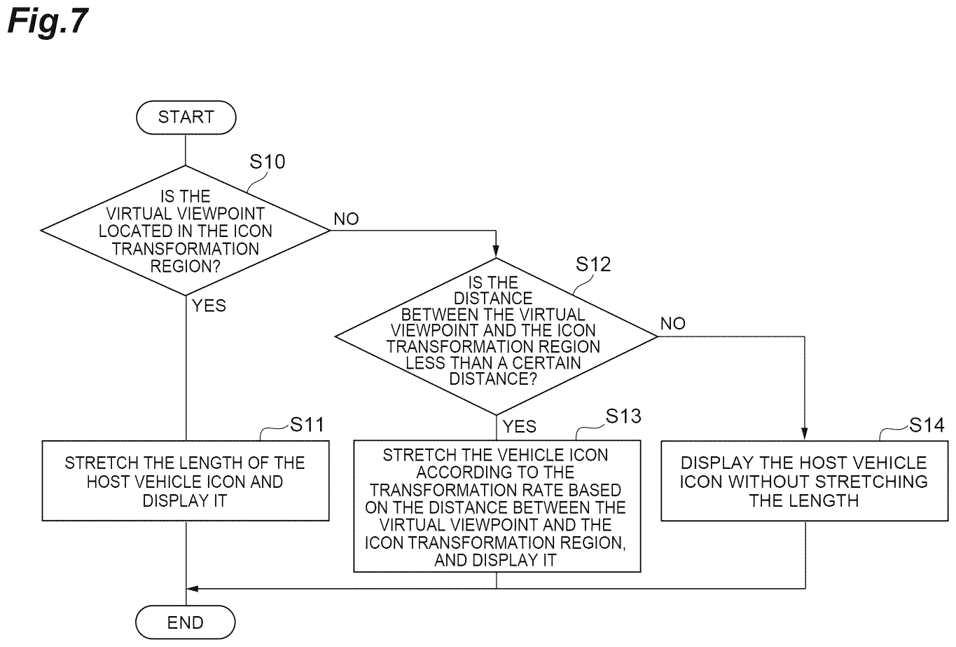

Next, a method for controlling the vehicle surrounding environment display device 100 according to the present embodiment will be described with reference to the drawings. FIG. 7 is a flowchart showing an example of a method for controlling the vehicle surrounding environment display device 100 according to the present embodiment.

As shown in FIG. 7, the ECU 10 of the vehicle surrounding environment display device 100 determines whether the virtual viewpoint 50 is located in the icon transformation region CA by the image display unit 12 in S10. When the ECU 10 determines that the virtual viewpoint 50 is located in the icon transformation region CA (S10: YES), the process proceeds to S11. When the ECU 10 determines that the virtual viewpoint 50 is not located in the icon transformation region CA (S10: NO), the process proceeds to S12.

In S11, the ECU 10 transforms the host vehicle icon M and performs screen display by the image display unit 12. The ECU 10 performs the stretching display to stretch the total length of the host vehicle icon M on the display 4 with a large transformation rate, for example. Thereafter, the current process ends.

In S12, the ECU 10 determines whether the distance between the virtual viewpoint 50 and the icon transformation region CA is less than a certain distance by the image display unit 12. When the ECU 10 determines that the distance between the virtual viewpoint 50 and the icon transformation region CA is less than a certain distance (S12: YES), the process proceeds to S13. When the ECU 10 determines that the distance between the virtual viewpoint 50 and the icon transformation region CA is not less than a certain distance (S12: NO), the process proceeds to S14.

In S13, the ECU 10 transforms the host vehicle icon M with a transformation rate according to the distance between the virtual viewpoint 50 and the icon transformation region CA and performs screen display by the image display unit 12. The ECU 10 performs image display so that the host vehicle icon M smoothly transforms with less sense of discomfort according to the change in the position of the virtual viewpoint 50 by the user. Thereafter, the current process ends.

In S14, the ECU 10 performs image display without transforming the host vehicle icon M by the image display unit 12. The host vehicle icon M is displayed in the initial setting shape, for example. Thereafter, the current process ends.

According to the vehicle surrounding environment display device 100 and the method for controlling the same according to the present embodiment described above, the host vehicle icon M is transformed so that the total length of the host vehicle icon M becomes longer when the virtual viewpoint 50 is located in the icon transformation region CA compared to when the virtual viewpoint 50 is not located in the icon transformation region CA. This allows the vehicle surrounding environment display device 100 and the method for controlling the same to suppress the user's sense of discomfort in recognizing the surrounding environment of the host vehicle using the virtual space compared to the actual space.

In addition, the vehicle surrounding environment display device 100 performs animation control to smoothly transform the host vehicle icon M according to the distance between the virtual viewpoint 50 and the icon transformation region CA. This allows the vehicle surrounding environment display device 100 to suppress the user's sense of discomfort in the transformation of the host vehicle icon M.

Furthermore, the vehicle surrounding environment display device 100 does not perform the stretching display of the host vehicle icon M regardless of the position of the virtual viewpoint 50 when no object is detected within the object proximity determination area including the host vehicle. This allows the vehicle surrounding environment display device 100 to avoid unnecessary transformation of the host vehicle icon M.

Although the embodiment of the present disclosure has been described above, the present disclosure is not limited to the above-described embodiment. The present disclosure can be carried out in various forms with various modifications and improvements based on the knowledge of those skilled in the art.

The vehicle surrounding environment display device 100 may set the icon transformation region CA above and in front of the host vehicle icon M. The vehicle surrounding environment display device 100 may set the icon transformation region CA both in front of and above the front and behind and above the rear of the host vehicle icon M.

The vehicle surrounding environment display device 100 does not necessarily need to smoothly transform the host vehicle icon M according to the position change of the virtual viewpoint 50. The vehicle surrounding environment display device 100 may transform the shape of the host vehicle icon M in a manner that compares the case where the virtual viewpoint 50 is located in the icon transformation region CA with the case where the virtual viewpoint 50 is not located in the icon transformation region CA.

What is claimed is:

1. A vehicle surrounding environment display device configured to generate a virtual space corresponding to a surrounding environment of a host vehicle on the basis of detection information from an external sensor of the host vehicle and display an image inside the virtual space viewed from a virtual viewpoint operated by a user of the host vehicle on a display,
wherein a three-dimensional host vehicle icon corresponding to the host vehicle is disposed in the virtual space, and
when the virtual viewpoint is located in an icon transformation region set above the rear or front of the host vehicle icon, the host vehicle icon is displayed in a stretching display that is stretched in length of the host vehicle icon compared to when the virtual viewpoint is not located in the icon transformation region.

2. The vehicle surrounding environment display device according to claim 1, wherein when the virtual viewpoint is not located in the icon transformation region, the farther the virtual viewpoint is from the icon transformation region, the closer the length of the host vehicle icon is to a preset initial length, and the closer the virtual viewpoint is to the icon transformation region, the more the length of the host vehicle icon is stretched.

3. The vehicle surrounding environment display device according to claim 1, wherein when no object is detected within a predetermined object proximity determination area including the host vehicle, the stretching display is not performed regardless of the position of the virtual viewpoint.

4. The vehicle surrounding environment display device according to claim 2, wherein when no object is detected within a predetermined object proximity determination area including the host vehicle, the stretching display is not performed regardless of the position of the virtual viewpoint.

5. The vehicle surrounding environment display device according to claim 1, wherein a transformation rate of the stretching display is changed according to the position of objects around the vehicle.

6. The vehicle surrounding environment display device according to claim 2, wherein a transformation rate of the stretching display is changed according to the position of objects around the vehicle.

7. The vehicle surrounding environment display device according to claim 3, wherein a transformation rate of the stretching display is changed according to the position of objects around the vehicle.

8. The vehicle surrounding environment display device according to claim 4, wherein a transformation rate of the stretching display is changed according to the position of objects around the vehicle.

9. A method for controlling a vehicle surrounding environment display device configured to generate a virtual space corresponding to a surrounding environment of a host vehicle on the basis of detection information from an external sensor of the host vehicle and display an image inside the virtual space viewed from a virtual viewpoint operated by a user of the host vehicle on a display,
wherein a three-dimensional host vehicle icon corresponding to the host vehicle is disposed in the virtual space, and
when the virtual viewpoint is located in an icon transformation region set above the rear or front of the host vehicle icon, the host vehicle icon is displayed in a stretching display that is stretched in length of the host vehicle icon compared to when the virtual viewpoint is not located in the icon transformation region.
